(19) United States
(12) Patent Application Publication
(10) Pub. No.: US 2013/0060534 A1
(43) Pub. Date: Mar. 7, 2013

(54) SYSTEMS AND METHODS FOR VALIDATING AND CUSTOMIZING OLIGONUCLEOTIDES SEQUENCES

(71) Applicants: Michael Scott Sample, St. Louis, MO (US); Stacey Hoge, St. Louis, MO (US); Parth Bhawalkar, St. Louis, MO (US); Simon Blackwell, St. Louis, MO (US); Richard Moloney, St. Louis, MO (US); Tina Rodgers, St. Louis, MO (US); Amber Walters, St. Louis, MO (US)

(72) Inventors: Michael Scott Sample, St. Louis, MO (US); Stacey Hoge, St. Louis, MO (US); Parth Bhawalkar, St. Louis, MO (US); Simon Blackwell, St. Louis, MO (US); Richard Moloney, St. Louis, MO (US); Tina Rodgers, St. Louis, MO (US); Amber Walters, St. Louis, MO (US)

(73) Assignee: SIGMA-ALDRICH CO., LLC, St. Louis, MO (US)

(21) Appl. No.: 13/598,922

(22) Filed: Aug. 30, 2012

Related U.S. Application Data
(60) Provisional application No. 61/530,933, filed on Sep. 2, 2011.
(60) Provisional application No. 61/530,932, filed on Sep. 2, 2011.

(51) Int. Cl. G06F 17/50

(52) U.S. Cl. 703/1

(57) ABSTRACT

A system and method is provided to customize and validate an oligonucleotide plate and/or tube design. A graphical user interface enables a user to submit oligo design data in a series of steps. One or more rules are used to validate the oligo plate design data as it is submitted. The graphical user interface also enables the user to modify oligonucleotide design data to correct errors and/or to obtain a valid oligonucleotide plate design.

### RELATED APPLICATIONS

This application takes priority to U.S. Provisional Patent Application No. 61/530,932 and U.S. Provisional Patent Application No. 61/530,933 both filed Sep. 2, 2011, and both entitled Systems and Methods for Validating and Customizing Oligonucleotides Sequences, the entire contents of which are incorporated herein by reference.

### FEDERALLY SPONSORED RESEARCH OR DEVELOPMENT

Not Applicable.

### COMPACT DISK APPENDIX

Not Applicable.

### BACKGROUND

Oligonucleotides are small sequences of genetic material up to about 200 bp (base pairs) in length that are used in a wide variety of biological research and biotech applications. Oligonucleotides, for example, are used in procedures such as DNA microarrays, Southern blots, ASO analysis, fluorescent in situ hybridization (FISH), and in the synthesis of artificial genes. Existing automated oligonucleotide synthesis devices are capable of producing oligonucleotides of virtually any specified sequence up to about 200 bases. Using these automated devices, numerous commercial entities synthesize oligonucleotides to order in a variety of formats, including columns, multi-well plates, and array formats.

For the biotech researcher, the process of ordering a custom-made oligonucleotide product from a commercial entity may be a bewildering experience, and the ever-expanding multitude of product options further complicates this process. Each selection of a product option may impose limitations on other aspects of the desired product due to manufacturing constraints or incompatibility of different aspects of the desired product. For example, the specified length of an oligonucleotide may limit the available purification methods or amount of oligonucleotide produced per batch. Many of these issues may be addressed if the researcher places an order by communicating with a sales representative of the commercial entity. However, when using an existing on-line application to place an order directly with the commercial entity, the burden of specifying an oligonucleotide product that complies with all manufacturing and compatibility constraints shifts to the researcher placing the on-line order. If the on-line order fails to comply with these constraints, the order may be delayed until a representative of the commercial entity contacts the researcher for clarification.

A need exists for an on-line application for ordering a custom-made oligonucleotide product, such as a multi-well plate containing the oligonucleotides, which simplifies the process of specifying the desired product. In particular, a need exists for an on-line application for ordering a custom-made oligonucleotide product which guides the user through the ordering process and limits the available options to those options compatible with previous user inputs, or provides critical information to the user based on previous inputs that informs subsequent user inputs.

### SUMMARY

According to one aspect, a method is provided for generating and validating an oligonucleotide container design that includes oligonucleotide container design data. The method includes retrieving at least one oligonucleotide constraint from a memory at at least one processor and receiving at least one input identifying at least one portion of the oligonucleotide container design data at the at least one processor. The method further includes automatically and continuously validating the oligonucleotide container design data with the at least one oligonucleotide constraint at the at least one processor.

In another aspect, a system is provided for generating and validating an oligonucleotide container design that includes oligonucleotide container design data. The system includes at least one processor, at least one database that includes at least one rule, and an application that is executed by the at least one processor. The application receives at least one input identifying at least one portion of the oligonucleotide container design data at the at least one processor and generates a validation request. In response to the validation request received at the at least one processor, the application retrieves the at least one rule from the at least one database and compares the at least one rule to the oligonucleotide container design data to determine if the oligonucleotide container design data is valid.

In yet another aspect, a system is provided for generating and validating an oligonucleotide container design that includes oligonucleotide container design data. The oligonucleotide container design data includes format data, sequence data, specification data, at least one packaging option, and any combination thereof. In this aspect, the system includes a computing device with at least one processor, at least one database, and a CRM configured with an application that includes a plurality of modules executable by the at least one processor. The at least one database contains at least one rule that may include at least one format rule, at least one sequence rule, at least one specification rule, and any combination thereof.

In this aspect, the modules of the application include a GUI module to display at least one input form and to receive at least one input identifying at least one portion of the oligonucleotide container design data. The application also includes a format validation module to retrieve at least one format rule from the at least one database, compare the at least one format rule to the format data to determine if the format data is valid, generate a format input form for display by the GUI module, and to receive a corrected portion of the format data via the GUI module. The format input form includes at least one display element corresponding to an invalid portion of the format data.

The application also includes a sequence validation module to retrieve at least one sequence rule from the at least one database, compare the at least one sequence rule to the sequence data to determine if the sequence data is valid, generate a sequence input form for display by the GUI module, and to receive a corrected portion of the sequence data via the GUI module. The sequence input form includes at least one display element corresponding to an invalid portion of the sequence data.

The application also includes a specification validation module to retrieve at least one specification rule from the at least one database, compare the at least one specification rule to the specification data to determine if the specification data is valid, generate a specification input form for display by the GUI module, and to receive a corrected portion of the specification data via the GUI module. The specification input form includes at least one display element corresponding to an invalid portion of the specification data.

### BRIEF DESCRIPTION OF THE DRAWINGS

FIGS. 1A-1B are block diagrams of computing environments for customizing and validating oligonucleotide sequences according to aspects of an oligonucleotide configuration system.

FIG. 2 depicts a top view of an oligonucleotide plate.

FIG. 3 is a block diagram of a oligonucleotide configuration application according to one aspect of the oligonucleotide configuration system.

FIGS. 4A-4K are screen shots of data entry forms according to one aspect of the oligonucleotide configuration system.

FIG. 4L is a screen shot of a cost detail screen according to one aspect of the oligonucleotide configuration system.

FIG. 5 is a block diagram of an exemplary embodiment of a constraint-based rules validation process.

FIG. 6 is a block diagram of another exemplary embodiment of a constraint-based rules validation process.

### DETAILED DESCRIPTION

Aspects of an oligonucleotide configuration system (OCS) described herein enable the customization and validation of oligonucleotide (oligo) sequences and/or oligo container designs for at least one oligonucleotide. Each oligonucleotide may be situated within a single container, which may be any container known in the art including, but not limited to a tube or a well in a plate. An oligo plate includes an array of wells that each contains an amount of oligonucleotide molecules having a particular sequence. An oligo tube includes any sealed container such as a plastic or glass tube sealed with a threaded cap or any other oligonucleotide container that contains an amount of oligonucleotide molecules. The amount of nucleotide molecules may be provided in one tube, or in two or more tubes.

The at least one oligonucleotides and associated single containers make up the oligonucleotide container design. For example, the oligonucleotide container design may be a 96-well plate containing a nucleotide in each well of the plate. In another example, the oligonucleotide container design may be a box of tubes, with a oligonucleotide contained in each tube.

In one aspect, the OCS provides a graphical user interface via a computing device that enables a user to submit oligo container design data in a series of steps. The OCS uses one or more rules to automatically and continuously validate aspects of the oligo container design data as it is submitted against rules-based constraints. The OCS also enables a user to interact with individual oligo sequences included in the container design to correct errors and/or modify container design data to obtain a valid customized oligo container design. The OCS similarly may be used for tube designs that include customized oligos and other format designs.

In addition to container and format designs that include oligonucleotides, the rules-based constraints of the OCS may be modified to enable the customization and validation of a variety format designs that include a variety of biomolecules, including but not limited to DNA, RNA, siRNA, and proteins. The biomolecules may include modifications in order to impart a desired property to the biomolecule. For example a modification may include a moiety that functions as a signal to facilitate the detection of the biomolecule during an experimental procedure. These modifications may be situated on either the 5′ or 3′ ends of DNA and RNA oligos, or on the N terminus or C terminus of protein oligos. These modifications may also anywhere occur within the central portion of the oligo. Rules-based constraints may be defined to limit the container designs generated by the OCS to those designs that are compatible with the oligo synthesis devices and other physical and chemical constraints.

Other aspects of the OCS determine specification options available for a particular oligo container design (e.g., plate design, tube design) or other format based on one or more other rules. The OCS then displays the available specification options to the user. The OCS can also eliminate one or more of the displayed specification options and/or display additional specification options in response to a selection of a particular specification option.

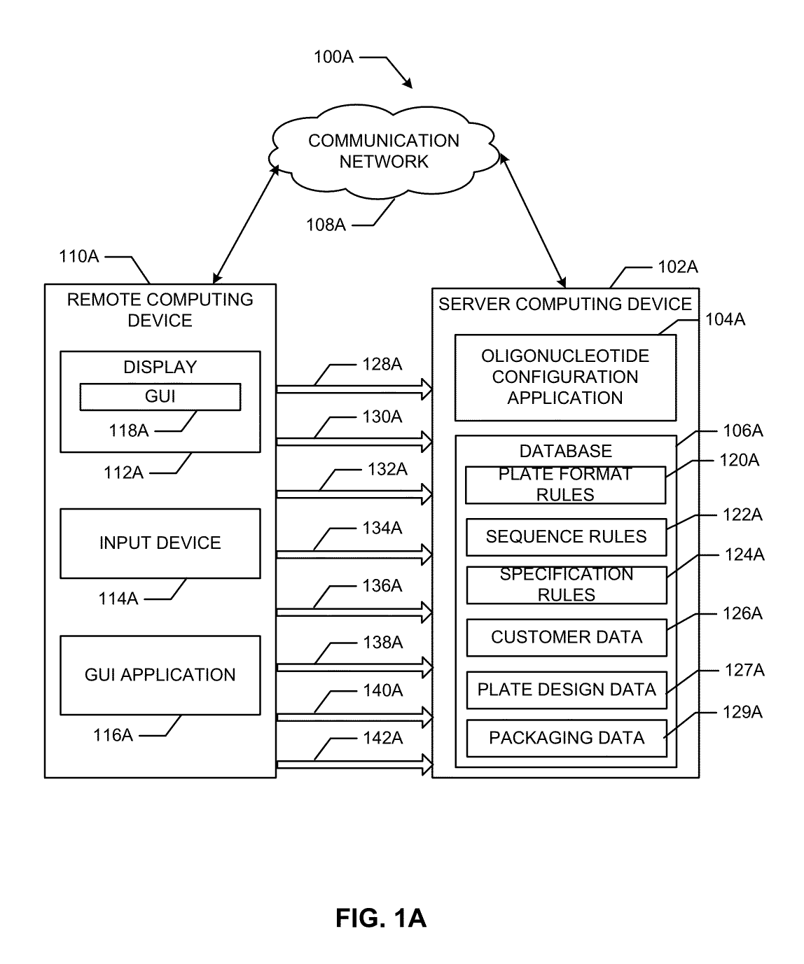

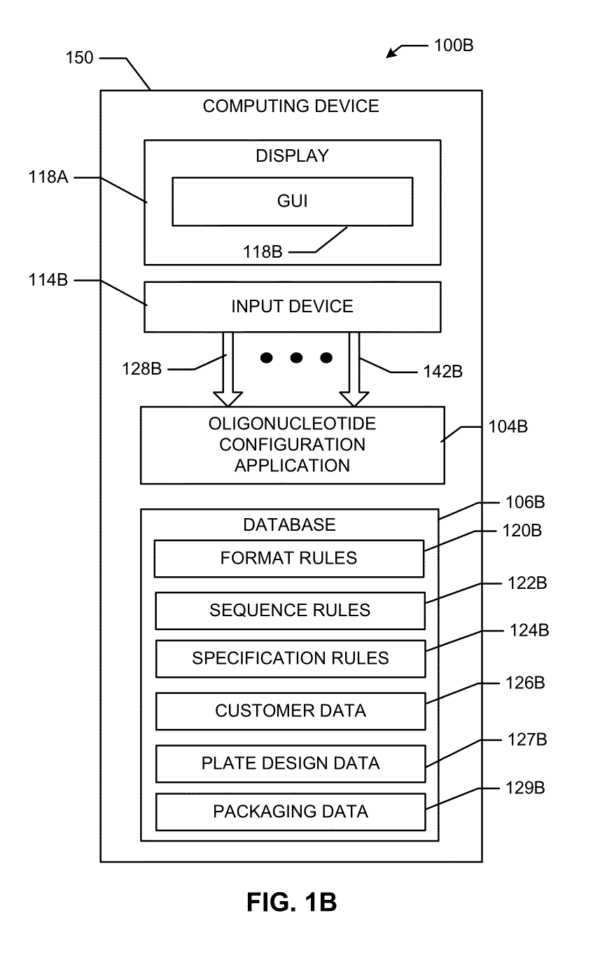

FIG. 1A depicts an exemplary embodiment of an OCS 100A according to one aspect of the invention. The OCS 100A includes a server computing device (“server”) 102A with an oligonucleotide configuration application (OCA) 104A and a database 106A that communicates through a communication network 108A to a remote computing device (“remote device”) 110A.

The server 102A includes one or more processors and memory and is configured to receive data and/or communications from, and/or transmit data and/or communications to the remote device 110A via the communication network 108A.

The communication network 108A can be the Internet, an intranet, or another wired or wireless communication network. In this example, the remote device 110A and the server 102A may communicate data between each other using Hypertext Transfer Protocol (HTTP), which is a protocol commonly used on the Internet to exchange information between remote device computers and servers. In another aspect, the remote device 110A and the server 102A may exchange data via a wireless communication signal, such as using a Wireless Application Protocol (WAP), which is a protocol commonly used to provide Internet service to digital mobile phones and other wireless devices.

According to one aspect, the remote device 110A is a computing or processing device that includes one or more processors and memory and is configured to receive data and/or communications from, and/or transmit data and/or communications to the server 102A via the communication network 108A. For example, the remote device 110A can be a laptop computer, a personal digital assistant, a tablet computer, standard personal computer, or another processing device. The remote device 110A includes a display 112A, such as a computer monitor, for displaying data and/or graphical user interfaces. The remote device 110A may also include an input device 114A, such as a keyboard or a pointing device (e.g., a mouse, trackball, pen, or touch screen) to enter data into or interact with graphical user interfaces.

The remote device 110A also includes a graphical user interface (or GUI) application 116A, such as a browser application, to generate a graphical user interface 118A on the display 108A. The graphical user interface 118A enables a user of the remote device 110A to interact with data entry forms received from the server 102A, to submit container designs, such as oligo plate, tube rack, or other format design data to the OCA 104A for validation, and/or to place orders based on validated oligo plate, tube rack, or other format design data.

According to one aspect, the database 106A stores a plurality of rules for validating oligo plate, tube rack, or other format design data. The stored rules define, for example, one or more constraints that can be used to determine if container design data is valid. The constraints are limitations or restrictions for an oligo plate design based on the available oligo plate types such as 96-well plates, the operating conditions of the oligo synthesis device used to produce the oligo plate, the chemical properties of the oligo sequences governed by factors such as sequence length and number of consecutive G nucleotides. There may be specific types of rules for a particular type of plate design data. For example, plate design data can include plate format data, plate sequence data, and plate specification data. In this example, the database 106A stores format rules 120A, sequence rules 122A, and specification rules 124A for plate, tube rack, or other format designs.

The plurality of rules may differ depending on the particular biomolecule included in the oligo plate, tube rack, or other format design. For example, if the oligo is a oligonucleotide, the sequence elements are typically limited to one of four bases: T, G, C, or A, as well as a limited number of other elements such as Wobble bases (B,M,V,D,N,W,H,R,Y,K,S), Inosine (I), and 2′O-methyl bases by the plurality of rules. In another example, if the oligo is a protein, the sequence elements may be limited to the standard peptide bases such as Ser, Thr, Tyr, and others. The plurality of rules may also differ depending on the particular biomolecule due to differences in the allowable modifications, sequence lengths, and other aspects of the format design.

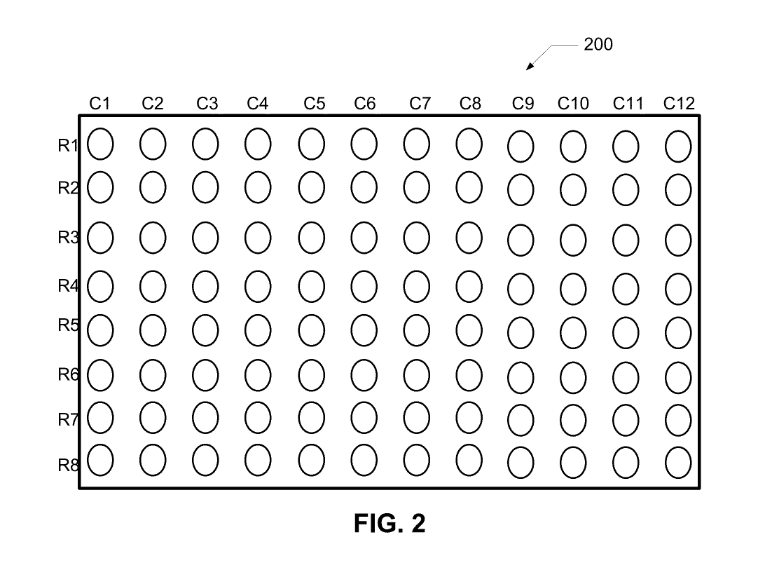

Plate format rules 120A define acceptable matrix sizes for an oligo plate with wells configured in a column and row format. For example, the oligo plate format rules (e.g., 120A, 120B) may define a plate configured with 8 rows of wells and 12 columns of wells (i.e., an 8×12 plate or a 96 well plate) as a valid format. FIG. 2 depicts an example of a top view of an oligo plate or micro tray. The plate 200 is configured with well rows 1 thru 8 (R1-R8) and well columns 1 thru 12 (C1-C12). As explained above, this format has been referred to as a 96 well plate. As another example, the oligo plate format rules 200 may define a plate configured with 16 rows of wells and 24 columns of wells (i.e., a 16×24 plate or a 384 well plate) as a valid format. Other examples of plate format rules 120A exists. For example, the plate format rules may define acceptable tube sizes, tube materials, or number of tubes included in a format design.

Sequence rules 122A define acceptable characters or elements that can be included in a particular sequence or a particular type of sequence. For example, the sequence rules specify that characters included in a DNA type sequence must be C, G, T or A to be a valid sequence. As another example, sequence rules may specify a valid length range (e.g., 2 to 120 base pairs) for each sequence. As yet another example, sequence rules may specify a maximum number of consecutive characters within a sequence (e.g., no more than 6 consecutive Gs). Other examples of specification rules exist. For example, the sequence rules may specify that the characters included in a protein sequence must be Ser, Tyr, Thr, or characters representing other valid amino acid elements.

Plate specification rules 124A define acceptable oligo plate design parameters including but not limited to the form of oligonucleotide, the amount of oligonucleotide, the type of plate, and the packaging of the plate for shipping. The plate specification rules 124A may define acceptable forms of the oligonucleotide as including dry oligonucleotide, oligonucleotide in solution with water, oligonucleotide in solution with TE buffer (tris(hydroxymethyl)aminomethane and ethylenediaminetetraacetic acid), and oligonucleotide in solution with Tris buffer (tris(hydroxymethyl)aminomethane). Acceptable purification methods for the oligonucleotides may be defined by the plate specification rules 124A as including desalt method, cartridge method, HPLC (high-performance liquid chromatography) method, or PAGE (polyacrylamide gel electrophoresis) method. The plate specification rules 124A may define the acceptable format in which the desired amount of oligonucleotide may be defined in terms of a synthesis scale or in terms of a concentration of oligonucleotide per well. Synthesis scale, defined herein as the total amount of oligonucleotide produced, may be limited to an acceptable range from about 0.025 μmol to about 1 μmol by the plate specification rules. The synthesis scale may be specified by the user or the synthesis scale may be calculated based on the user-specified concentration of oligonucleotide per well and the user-specified well volume. The concentration of oligonucleotide per well of the tray may be limited by the plate specification rules to an acceptable concentration range from about 5 μM to about 500 μM per well. The oligo plate may be shipped at ambient temperature, frozen, or with an ice pack, as defined by the plate specification rules 124A. It is contemplated that specification rules may correspond to other types of containers.

The ranges and options defined by each plate specification rule 124A may further depend upon a subset of specification options input by the user. For example, the plate specification rules 124A may define HPLC as an acceptable purification method only for sequences ranging from about 10 bp to about 100 bp in length. In another example, the plate specification rules 124A may define the minimum acceptable synthesis scale as 0.025 μmol for sequence lengths ranging from about 10 bp to about 50 bp, and may define the minimum acceptable synthesis scale as 0.05 μmol for sequence lengths falling outside of the range from about 10 bp to about 50 bp. In yet another example, the plate specification rules 124A may define a minimum acceptable amount of oligonucleotide per well as about 0.1 nmol and shipping at ambient temperature as the only acceptable shipping method if a dry form of the oligonucleotide is selected by the user.

The ranges and options defined by each plate specification rule 124A may further depend upon a subset of specification options calculated from user-input plate specification options. For example, the acceptable concentration of oligonucleotide per well may be limited to a range calculated by dividing a user-specified amount of oligonucleotide per well by the acceptable range of well volumes defined by a plate specification rule 124A. In this example, the acceptable range of well volumes may further depend on a user-specified plate type, such as a shallow well PCR plate, a shallow well plate, or a deep well plate.

The plate specification options may be validated periodically to determine whether each plate specification option is valid according to all applicable plate specification rules 124A as the user inputs plate specification options via the remote computing device 110A. This validation may occur after each user input, after a fixed number of user inputs, after a selection of a control (e.g., next control), or at the completion of a set of inputs such as a set of inputs defining the packaging of the plate for shipping. If one or more of the user inputs is determined to be invalid according to one or more of the plate specification rules 124A, the invalid user inputs may be deleted or highlighted, and the user may be provided with an error message that may include the invalid user input, the range of acceptable user inputs according to the applicable plate specification rule 124A, and/or instructions for correcting the invalid user input.

The database 106A also includes customer data 126A for one or more customers. Customer data may include, for example, customer contact information, customer shipping information, and customer order history data. The database 106A also can also store validated plate design data 127A and/or packaging data 129A for each of one or more of the customers. Although FIG. 1A illustrates the database 106A as being located on the server 102A, it is contemplated that the database 106A can be located remotely from the server 102A in other aspects. For example, the database 106A may be located on a database server (not shown) that is communicatively connected to the server 102A.

In operation, the server 102A executes an oligonucleotide configuration application (OCA) 104A in response to an access request 128A received from the remote device 110A. Thereafter, the user can utilize the input device 114A to interact with one or more input forms received from the server 102A to generate one or more requests to submit to the OCA 104A. For example, as explained in more detail below, the user can use an input device 114A to interact with various data entry forms to generate the following requests: a format validation request 130A, a sequence validation request 132A, a specification entry request 134A, a view details request 136A, a modified sequence validation request 138A, a specification validation request 140A, and a cost detail request 142A. Other examples of requests that can be generated exist.

Each of the above requests may be submitted to the OCA 104A at different points during, for example, an ordering process, and each request may include a different type of plate design data. As explained in more detail below, plate design data can include format data, sequence data, and specification data. The OCA 104A is configured to validate each type of plate design data as it is entered during the ordering process. By validating each type of plate design data as it is entered, the OCA 104A enables automatic continuous and real-time validation of plate design data and, thus, a more efficient validation process. Similarly, the OCA 104A can receive and validate design data for other formats, including but not limited to tubes.

Although FIG. 1A illustrates a remote device 110A communicating with the server 102A that is configured with the OCA 104A, in other aspects it is contemplated that an OCS 100B can be implemented on a single computing device. For example, as shown in FIG. 1B, a computing device 150 executes an OCA 104B and contains the database 106B. The database 106B stores similar data (e.g., plate form rules 120B, sequence rules 122B, specification rules 124B, customer data 126B, plate design data 127B, and packaging data 129B) to the data stored by database 106A described above in connection with FIG. 1A. As a result, a user may interact with data entry forms displayed via the graphical user interface 118B on the display 112B via the input device 114B to execute the OCA 104B and to generate the various requests described above in connection with FIG. 1A (e.g., 128B-142B).

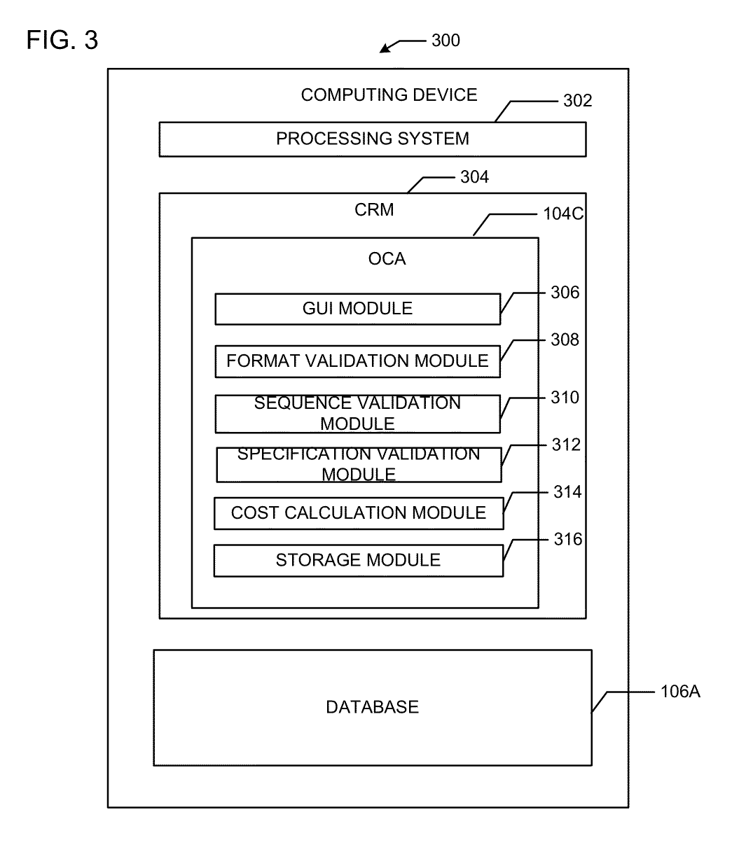

FIG. 3 is a block diagram depicting an exemplary OCA 104C executing on a computing device 300. According to one aspect, the computing device 300 includes a processing system 302 that includes one or more processors or other processing devices. The processing system 302 executes an exemplary OCA 104C to customize and/or validate oligo plate design data received from a remote device (e.g., remote device 110A, not shown) or entered locally at the computing device 300. Other design data also may be received to customize and/or validate other format designs, including tube format designs.

According to one aspect, the computing device 300 includes a computer readable medium (“CRM”) 304 configured with the OCA 104A. The OCA 104A includes instructions or modules that are executable by the processing system 302 to enable a user to validate and/or customize oligo plate design data.

The CRM 304 may include volatile media, nonvolatile media, removable media, non-removable media, and/or another available medium that can be accessed by the computing device 300. By way of example and not limitation, computer readable medium 304 comprises computer storage media and communication media. Computer storage media includes nontransient memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

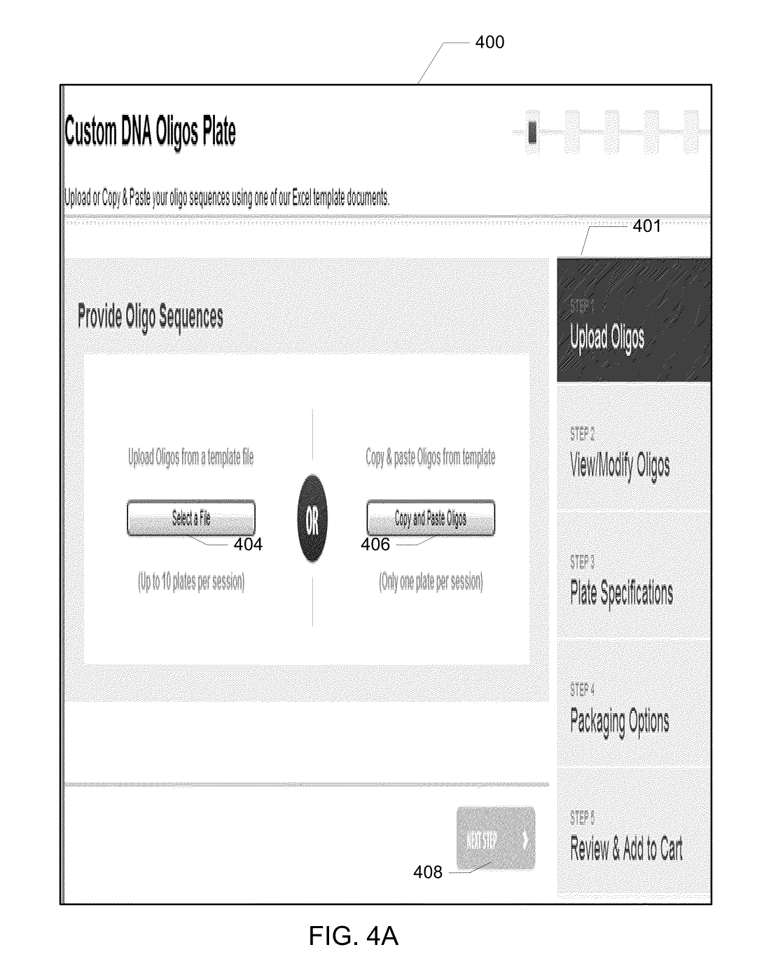

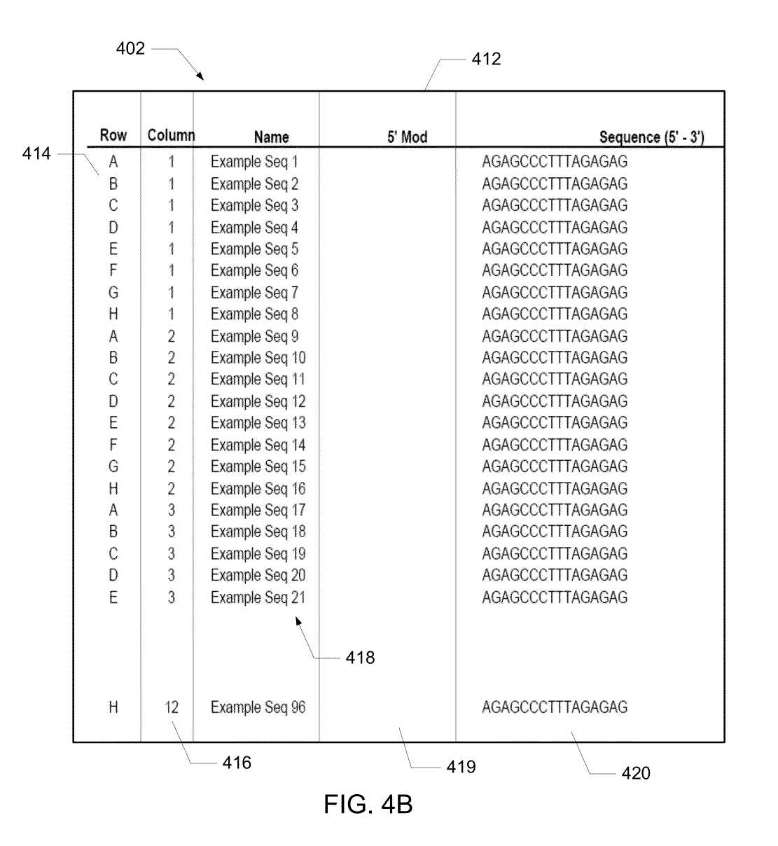

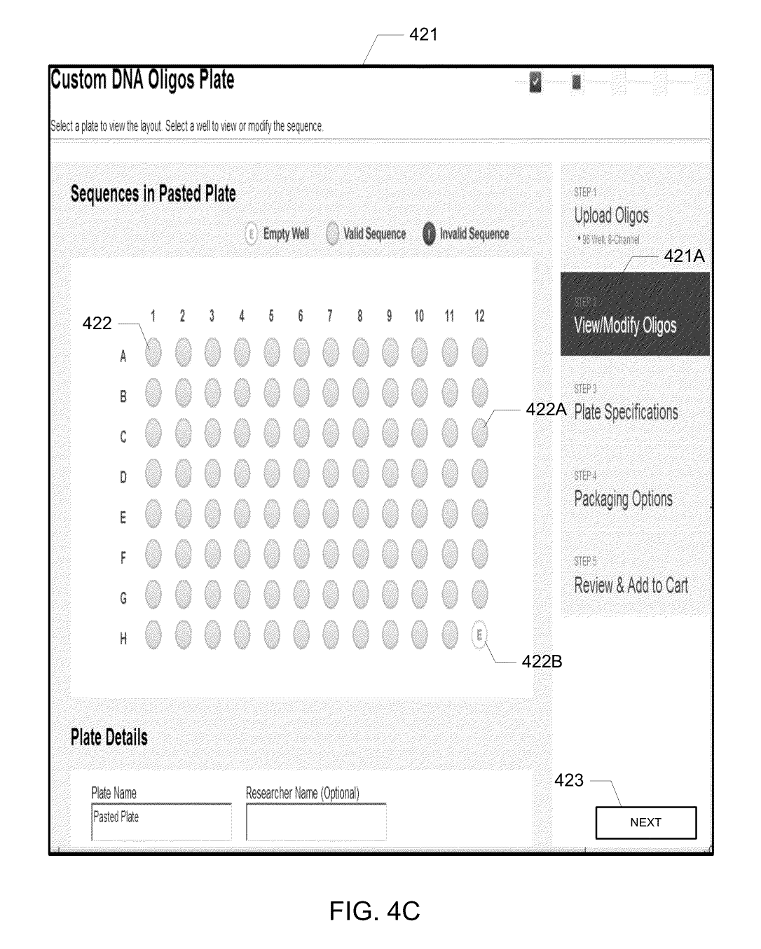

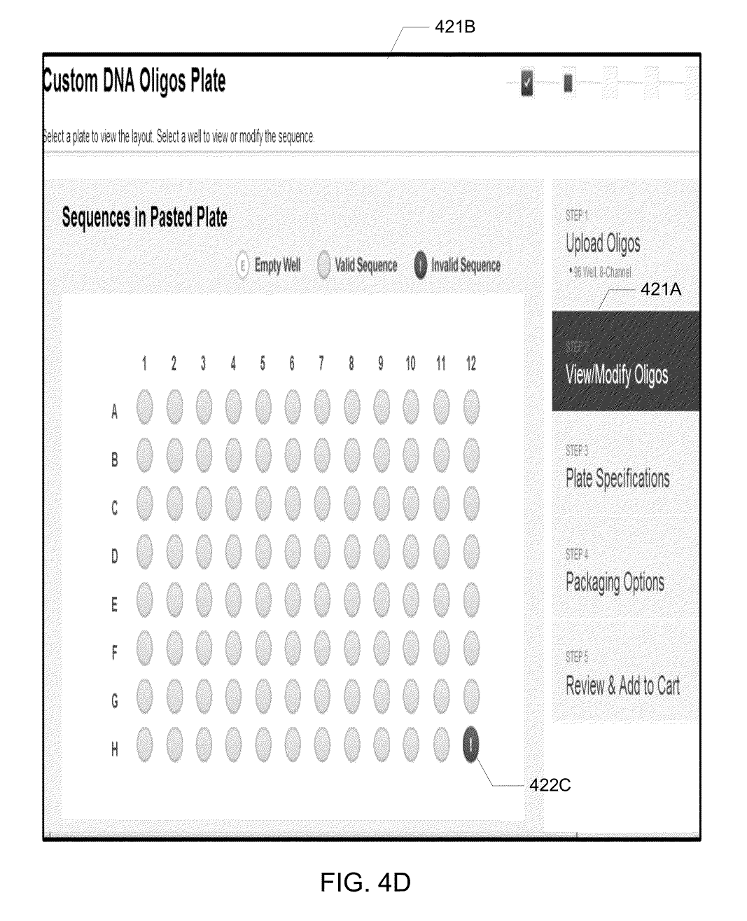

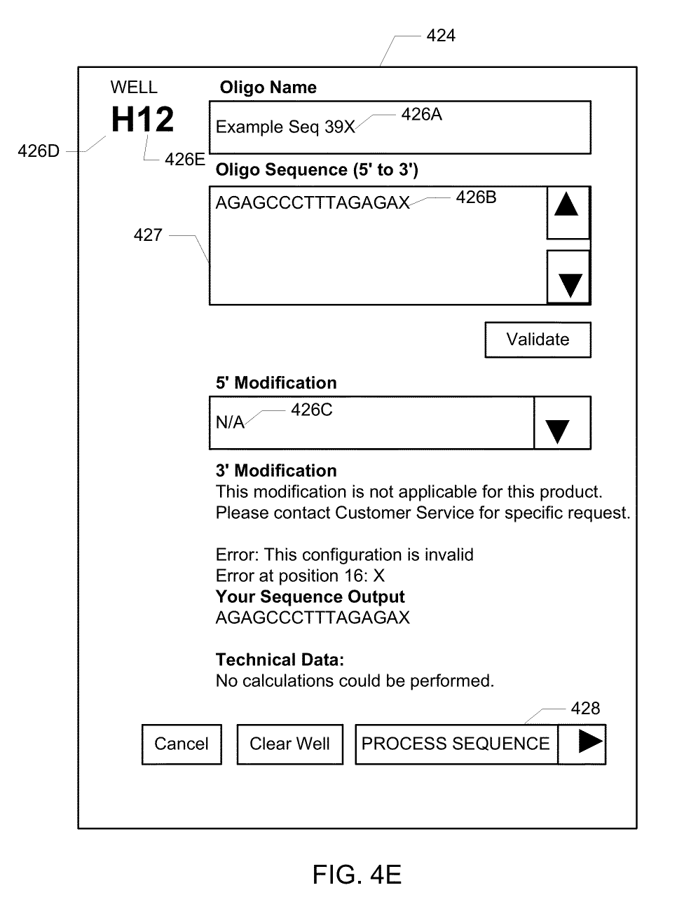

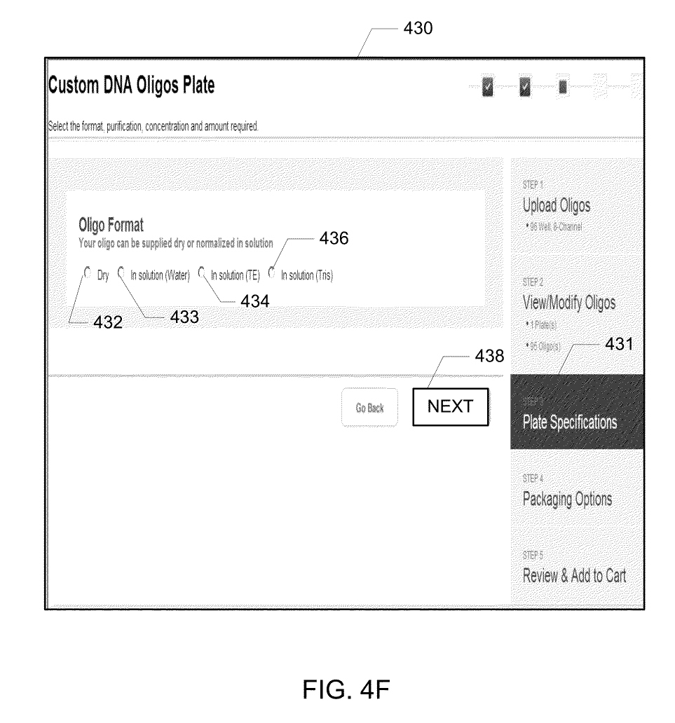

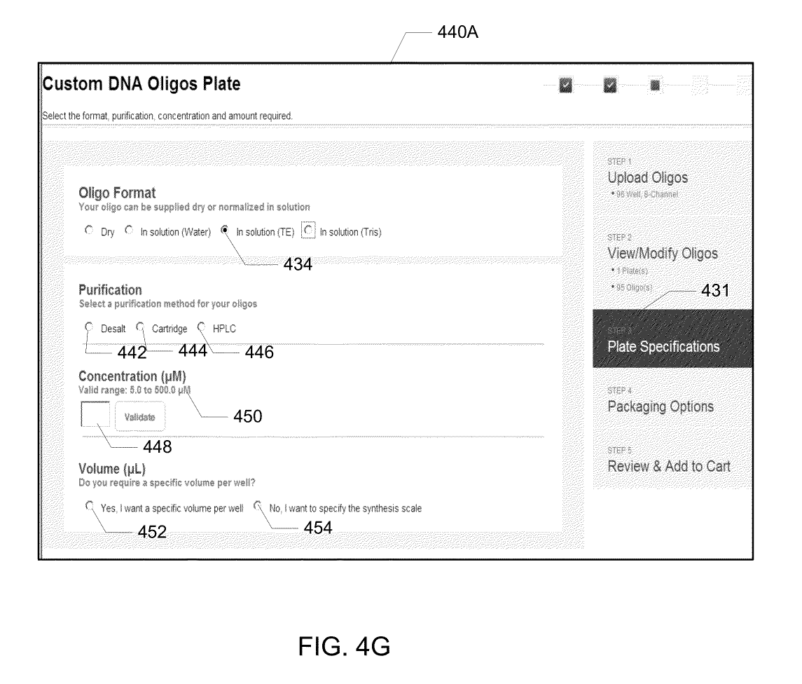

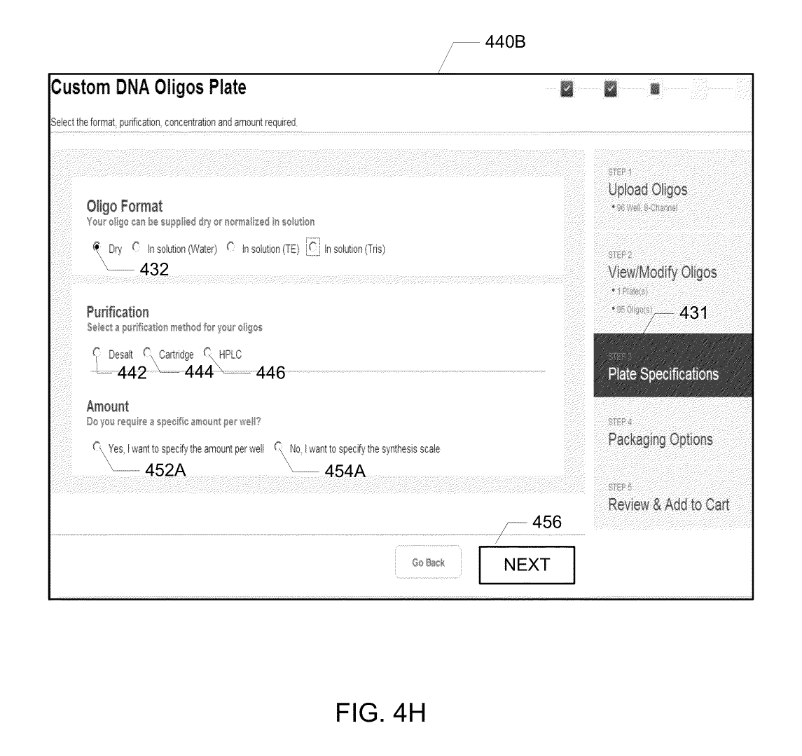

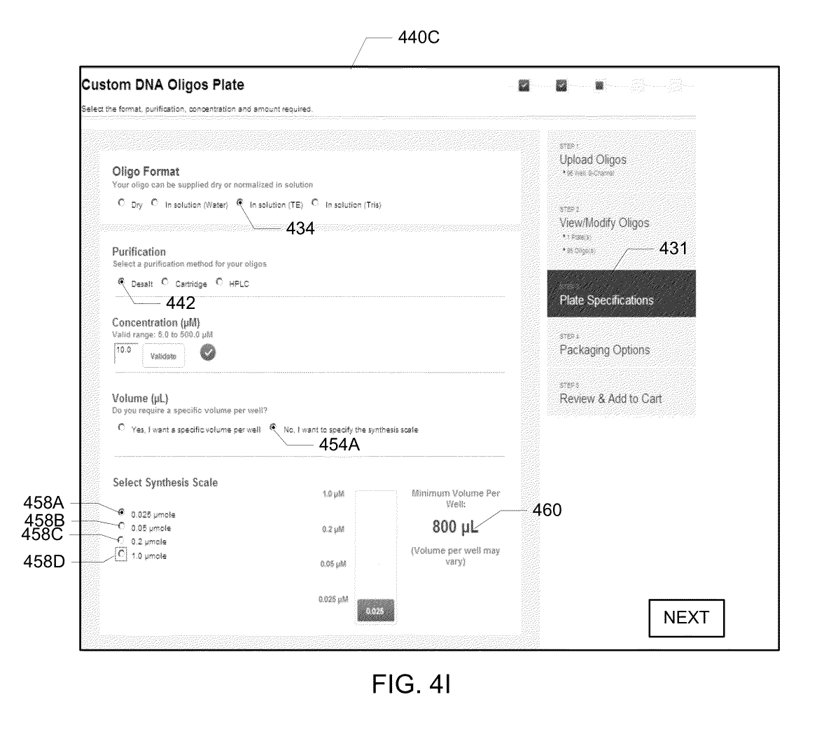

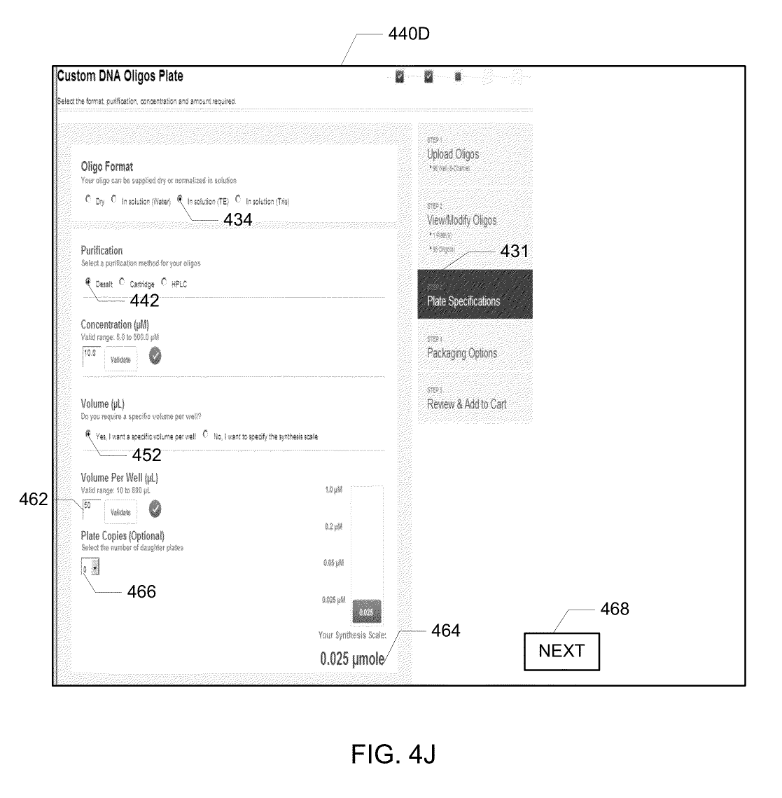

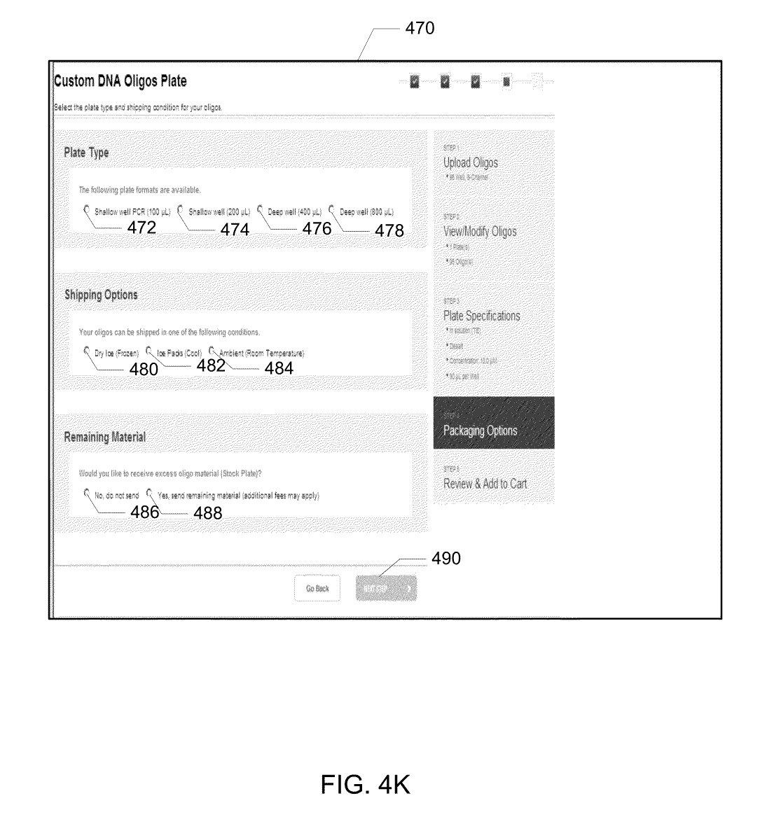

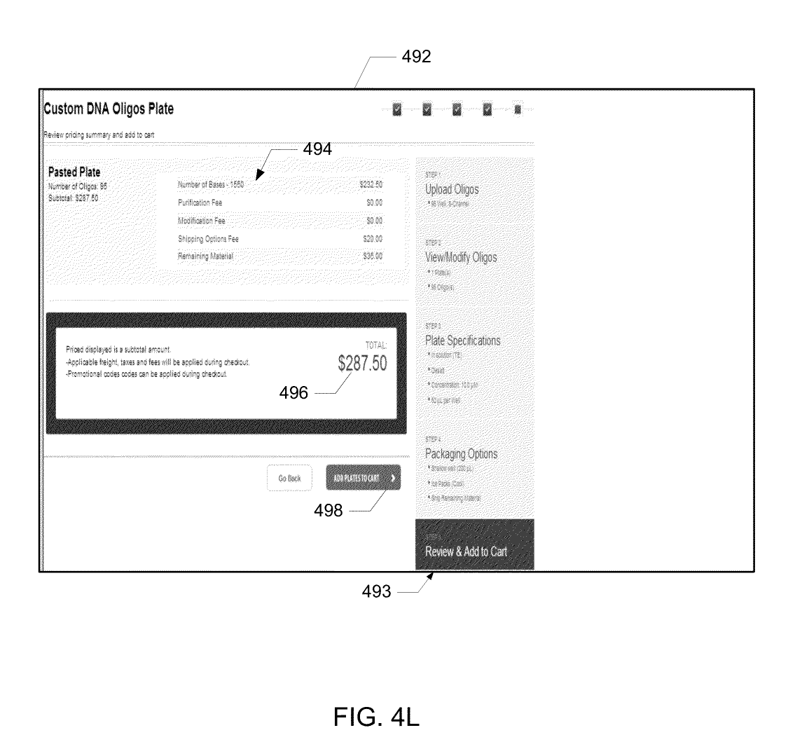

A GUI module 306 transmits one or more input forms to the remote device 110A (not shown) after the remote device 110A transmits an access request 128A (not shown) to the OCA 104C on the computing device 300, for example, by entering a uniform resource locator (URL) via the remote device 110A. As described above, the user of the remote device 110A interacts with one or more input forms received from the computing device 300 to generate one or more other requests (e.g., requests 130A-138A) to submit to the OCA 104C. FIGS. 4A-4L depict exemplary screen shots of the one or more input forms transferred to the remote device 110 by the GUI module 306.

FIG. 4A depicts an exemplary input designation selection form 400 that enables the user to designate the method for loading one or more oligos 401 for inclusion into the customized plate design data 402 (not shown) for processing. By selecting a “Select a File” control 404, the user can browse files stored on the remote device 102A and/or storage devices (not shown) connected to the remote device 102A and select a desired plate design document file. Alternatively, by selecting a “Copy and Paste Oligos” control 406, the user can copy the content of a desired plate design document with one or more oligos and paste that content into a displayed window (not shown). According to one aspect, the plate design document is in a spreadsheet format.

FIG. 4B depicts an exemplary plate design document 412 containing plate design data 402. The plate design data includes format data and sequence data for a particular plate design. In this example, the format data (i.e., plate size) can be determined from columns 414 and 416 of the design document 412. For example, column 414 specifies the row of a well assigned a particular sequence in a plate design. The values in the column 414 can be a letter from A to H, where A corresponds to R1 and H corresponds to R8 of the plate 200 in FIG. 2. Column 416 specifies the column of a well assigned a particular sequence in a plate design. The values in the column 416 can be a number from 1 to 12 where 1 correspond to C1 and 12 corresponds to C12 in FIG. 2. Thus, the format data included in column 414 and column 416 corresponds to an 8×12 plate or a 96 well plate. Values and/or characters other than the letters and numbers in the above example may be used.

Sequence data can be determined from column 418 and column 420 of the design document 412. In this example, column 418 specifies the names of sequences assigned to a particular row and column of a plate design. Column 420 specifies the series of elements that define a particular sequence assigned to a particular row and column of a plate design. Accordingly, the plate design document 412 allows a user to assign a name and desired sequence elements to a particular well in a plate. For example, the sequence named “Example Seq 18” in the plate design document 412 is to be located in the well located in the second row and third column and includes the following sequence of elements “AGAGCCCTTTAGAGAG.”

Modifications to the 5′ end of the oligo for a particular sequence may be determined from entries in column 419. These modifications may be attached to the sequence defined in column 420 at its 5′ end (i.e., at the left end of the sequences shown in column 420). Non-limiting examples of modifications that may be included in column 419 include: an amine C6 linker (AMC6F or AMC6T), an amine C12 linker (AMC12), phosphorylation (PHOS), Biotin (BTN), 6 FAM dye (6FAM), HEX dye(HEX), or TET dye (TET).

Referring back to FIG. 4A, after the user selects a file or copies the desired plate design document, the user selects a “next step” control 408 to generate a format validation request 130A that includes format data and a sequence validation request 132A that includes the sequence data.

FIG. 4C depicts an exemplary plate design management form 421 that enables the user to view and modify oligos 421A for the plate layout for a submitted plate design. In this example, each well is represented by a display element 422, such as a circular shape. Each display element 422 is assigned an attribute, such as a color, a letter, a number, pattern, or symbol to indicate whether the sequence assigned to a corresponding well according to a plate design (such as specified in a plate design document) is valid, invalid, or empty. For example, if a sequence assigned to a particular well is deemed to be valid by the OCA 104C, the corresponding display element 422A is displayed in a color such as gray or green, or with a designation such as a “V” or a “*”. In an additional example, if a sequence assigned to a particular well is deemed to be invalid by the OCA 104C, the corresponding display element is displayed in a second color, such as red, or with a different designation such as an “I” or an “!”. In another example, if the plate design management form 421 indicates that the submitted plate design does not specify a sequence for a corresponding well, as determined by the OCA 104C, a third color such as white, or another designation, such as an “E”, may be displayed within a particular display element 422B to indicate that the well is empty. If the plate design management form 421 indicates that all sequences are valid, the user may select a “next step” control 423 to generate a specification entry request 134A.

FIG. 4D depicts an example of the plate design management form 421B at a well detail level that indicates an invalid sequence is present in the well located in the 8^{th} row and 12^{th} column (i.e., H12). The plate design management form 421 or 421B also enables the user to select one or more individual display elements for one or more wells to display a design details form by generating a view details request 136A for a corresponding selected well and modify the sequence currently assigned to the selected well.

FIG. 4E depicts an exemplary plate design details form 424 at a well summary level. The plate design details form 424 displays details about a selected well, such as the name 426A of the sequence assigned to the selected well, the sequence elements 426B, any suggested modifications 426C, and the row 426D and column 426E of the selected well within the plate layout for a submitted plate design. A user can also interact with the design details form 424 to modify or change the displayed details about the selected well. For example, the user can change the characters of the sequence 426B displayed in a sequence display field 427. After the user modifies or changes one or more characters in the displayed sequence, the user selects, for example, a process sequence control 428 to generate the modified sequence validation request 138A that includes the modified sequence data.

FIG. 4F depicts an exemplary composition format management form 430 that enables a user to designate a desired composition format of the oligonucleotide sequence entered via form 400 in the upload process 401 and/or viewed and/or modified via forms 421 and/or 421B in the view/modify oligos process 421A. For example, the user may designate a desired composition format by selecting a particular control, such as a radio control, adjacent to a desired composition. In this example, the user selects a control 432 to designate a dry oligonucleotide, selects a control 433 to designate an oligonucleotide in solution with water, selects a control 434 to designate an oligonucleotide in solution with TE buffer, or selects a control 436 to designate an oligonucleotide in solution with Tris buffer. After the user selects a desired composition, the user may select, for example, a “next” control 438 to view a plate specification management form 440.

FIG. 4G depicts an exemplary plate specification management form 440 that enables a user to input specification data for a desired oligonucleotide based on the composition designated via form 430 in the plate specifications process 431. For example, the plate specification management form 440A of FIG. 4G is generated after the selection of a control 434 in FIG. 4F designating the composition format of the oligonucleotide in solution with TE buffer. The specification management form 440A enables the user to select specification data by interacting with corresponding controls to select a purification method. The user may select a control 442 to designate desalt purification, a control 444 to designate cartridge purification, or a control 446 to designate HPLC purification.

The user can also enter a desired concentration amount for the plate design by entering a value in a concentration display window 448. The plate specification management form 440 may display a valid range of concentrations 450 above the concentration display window 448 to assist the user in selecting a valid concentration. This valid range of concentrations 450 is generated by the OCA 104A, and may incorporate one or more rules from the database 106A, as the rules apply to the validated plate design data 127A from the database 106A.

The user may further specify the manner in which the specific volume of the oligonucleotide in solution to be placed in each well is determined. The user may select control 452 to indicate that the user wishes to specify the volume of oligonucleotide in solution for each well of the plate design. Alternatively, the user may select control 454 to indicate that the user wishes to specify the synthesis scale, defined herein as a total volume of oligonucleotide to be produced and divided among the wells.

FIG. 4H depicts another exemplary plate specification management form 440B generated in response to the user's selection of the control 432 of FIG. 4F to specify a dry oligo format. In this example, because the designated composition is not a solution or liquid, the specification options related to concentration and volume are not displayed to comply with constraints of the rules from the database 106A. However, other controls that designate specification options that are relevant to the dry oligo format are displayed to comply with the constraints of the rules. For example, controls 442, 444, and 446 are displayed to provide the user the capability to designate the desired purification method, and controls 452A and 454A are displayed to provide the user the capability of designating the amount of oligo to be placed in each well. Because the dry oligo option was selected previously, controls 452A and 454A designate the amount of oligo per well, rather than the volume of oligo in solution per well. Once all controls have been selected and validated on the plate management form 440A, the user may select a “next” control 456 to specify the volume or amount per well or the synthesis scale as appropriate.

FIG. 4I depicts another exemplary plate specification management form 440C generated after the selection of the control 434 in FIG. 4F to designate an oligo in solution with TE buffer format, the control 442 to designate desalt purification, and the control 454A to indicate that the user will specify a synthesis scale. The controls in FIG. 4I are selected based on constraints in the rules stored in the database 106A based on selection of the control in FIG. 4F. In this example, the specification management form 440C enables the user to interact with corresponding controls to select a desired synthesis scale option, such as 0.025 μmol (control 458A), 0.05 μmol (control 458B), 0.2 μmol (control 458C), and 1.0 μmol (control 458D). In this example, synthesis scale options are displayed because the user previously selected an option to specify the synthesis scale by selecting control 454A. Further, the displayed range of synthesis scale options is limited by the constraints of the rules as applied to the validated plate design data 127A. For example, a rule may specify that the control 458A may be displayed only if the oligos are between 10 bp and 50 bp in length, with no 5′ modifications. The plate specification management form 440B also displays a minimum volume per well 460 (e.g., 800 μL); this minimum volume per well 460 is calculated by the OCA 104A based on the user-designated synthesis scale and oligo concentration.

FIG. 4J depicts another exemplary plate specification management form 440C generated after the selection of control 434 to designate an oligo in solution with TE buffer format, control 442 to designate desalt purification, and control 452 to indicate that the user will specify a specific volume of oligo in solution per well. In this example, the specification management form 440D enables the user to interact with the well volume input field 462 to enter a desired oligo solution volume per well. The plate specification management form 440C also displays a synthesis scale 464 calculated by the OCA 104A based on the user-designated volume per well and concentration of oligo solution. The plate specification management form 440C further displays an input control 466 that enables the user to designate whether and/or a number of plate copies desired. After the user designates the specification data for a validated plate design, the user selects a “next” control 468 to generate a specification validation request 140A that includes the designated specification data.

FIG. 4K depicts an exemplary packaging specification management form 470 for designating packaging options. The plate packaging specification management form 470 enables a user to designate packaging options related to a customized and validated oligonucleotide plate design validated in the plate specifications process 431. For example, the packaging specification management form 470 enables a user to interact with corresponding controls to select plate types, such as a 100 μL shallow well PCR plate (control 472), a 200 μL shallow well plate (control 474), a 400 μL deep well plate (control 476), or a 800 μL deep well plate (control 478). The packaging specification management form 470 further enables a user to interact with corresponding controls to select shipping conditions, such as frozen and/or packaged with dry ice (control 480), cool and/or packaged with ice packs (control 482), or at ambient or room temperature (control 484). In this example, the user can interact with corresponding controls 486 or 488 to designate whether to ship or dispose of any excess or remaining oligonucleotide material associated with the user's order. After the user completes the designation of the desired packaging and shipping options and the OCA 104A has validated all user inputs, the user may select a “next” control 490 to generate a cost detail request 142A that includes the designated format data, sequence data, specification data, and packaging options.

FIG. 4L depicts an exemplary cost detail form 492 for a review and add to cart process 493 that is generated after a user has interacted with the forms depicted in FIGS. 4F-4J to designate the plate specification data for a validated plate design. In this example, the cost detail form 492 provides itemized costs 494 for oligonucleotide material, purification fees, modification fees, shipping fees, remaining material, and total cost 496. The user can complete the order by selecting for example, an “add plates to cart” control 498.

“Scale”, as used in FIGS. 4G-4J, refers to the synthesis scale, defined herein previously as the molar amount of oligonucleotide produced as part of the oligonucleotide plate design. The scale, in an aspect, may be limited to one or more discrete values due to one or more factors associated with the method of producing the oligonucleotide. For example, the scale may be limited to values of 0.025 μmol, 0.05 μmol, 0.2 μmol, and 1.0 μmol, as illustrated in FIG. 4I in one aspect.

Referring back to FIG. 3, a format validation module 308 retrieves plate format rules 120A from the database 106A in response to the format validation request 130A. The format validation module 308 compares the retrieved plate format rules 120A to format data included in the format validation request 130A to determine if the plate design data 402 corresponds to a plate design with a valid format. For example, according to one aspect, the plate format rules 120A define the plate formats for 96 well plates in both 9-channel and 12 channel formats, as well as a 384 well plate. These plate formats include a maximum number of rows within the plate design data 402, as well as the maximum number of entries within each row. The format validation module 308 verifies that the format of the plate design data 402 is consistent with one of the formats defined by the rules and, thus, that the plate design data correctly conforms to one of the standard plate formats. If the format data complies with the format rules 120, the format validation module 308 either generates data or a message indicating the format data is valid. If the format data does not comply with the rules, the format validation module 308 displays an error message (or data for an error message) to inform the user that the plate design data is not in the correct format; this error message may further recommend corrective actions to be made by the user. If the plate design data 402 does correspond to one of the plate formats defined by the plate format rules 120, a plate format is designated by the OCA 104C and incorporated into the validated plate design data 127A.

The format rules 120 may be modified in order to validate format data associated with other design formats, such as tubes. In this example, the format validation module 308 validates format data for a tube rack or other format against the format rules to determine whether the format data is valid or not. The format validation module 308 either generates data or a message indicating the specification data is valid or generates data for an error message.

If the plate design data 402 complies with the plate format rules 120A, a sequence validation module 310 retrieves sequence rules 122A from the database 106A in response to the sequence validation request 132A. The sequence validation module 310 compares the retrieved sequence rules to sequence data included in the sequence validation request 132A to determine if the plate design data 402 includes valid sequences. As described above, sequence rules may specify that characters included in a particular type of oligonucleotide sequence (e.g., DNA) must have a certain value (e.g., C, G, T or A for DNA) to be a valid sequence. Thus, as one example, the sequence validation module 310 verifies that each of sequences in the plate design data has the appropriate characters. As another example, the sequence validation module 310 verifies that each of the sequences in the plate design data is within a valid sequence length range (e.g., 2 to 120 base pairs). As yet another example, the sequence validation module 310 verifies that the sequences in the plate design do not have more than a maximum number (e.g., 6 consecutive G nucleotides) of consecutive characters.

According to one aspect, the sequence validation module 310 assigns an invalid attribute flag to a particular well if the corresponding sequence does not comply with the sequence rules 122A. The sequence validation module 310 may assign a valid attribute flag to the particular well if the corresponding sequence complies with the sequence rules 122A. The sequence validation module 310 may assign a null or empty attribute flag to wells when a corresponding sequence is not specified by the plate design data. The GUI module 306 generates the plate design management form 421 or 421B, such as depicted in FIGS. 4C and 4D, for display according to attributes assigned by the sequence validation module 310.

In one aspect, the sequence validation rules need not be modified for different formats, and the same rules are used for plates, tubes, and other formats.

The GUI module 306 transmits the plate design details form 424 to the remote device 110A for display in response to the view details request 136A. As described above and illustrated in FIG. 4E, the plate design details form 424 displays details about a selected well, such as the name of the sequence 426A assigned to the selected well, the sequence elements 426B, any suggested modifications 426C, and the row 426D and column 426E of the selected well within the plate layout for a submitted plate design. If the user modifies the sequence data by entering sequence modifications into the entry window 427, a modified sequence validation request 138A is generated. The sequence validation module 310 compares the retrieved sequence rules to modified sequence data included in the modified sequence validation request 138A to determine if the modified plate design data 402 includes valid sequences in a manner similar to the processing of the sequence validation request 132A described above.

The GUI module 306 transmits the plate design details form 424 to the remote device 110A for display in response to the view details request 136A. As described above, the plate design details form 424 displays details about a selected well for a submitted plate design.

The GUI module 306 transmits the composition format management form 430 to the remote device 110A for display in response to the specification entry request 134A. The GUI module 306 further transmits the appropriate plate specification management form 440 to the remote device 110A for display based on the composition options selected via the composition format management form 430.

The specification validation module 312 retrieves specification rules 124A from the database 106A in response to the specification validation request 140A. The specification validation module 312 then compares the retrieved specification rules 124A to the specification data entered via a particular plate specification management form 440 by a user to determine if the specification data is valid. For example, the specification validation module 312 compares a concentration amount entered by the user via the entry field 448 of the plate specification management form 440 to valid concentration ranges defined by the retrieved specification rules 124A to determine if this entered concentration is valid. As another example, the specification validation module 312 compares a volume per well amount entered by the user via the entry field 462 of the plate specification management form 440D to a valid volume per well range defined by the retrieved specification rules 124A to determine if the entered volume per well is valid. If the specification data complies with the specification rules 124, the specification validation module 312 either generates data or a message indicating the specification data is valid. If the specification data does not comply with the specification rules 124A, the specification validation module 312 displays an error message (or data for an error message) to inform the user that the plate design data is not in the correct format. The GUI module 306 transmits a packaging specification management form 470 to the remote device 110A for display if the specification data complies with the specification rules 124A.

The specification rules 124A may be modified in order to validate specification data associated with other design formats, such as tubes. In this example, the specification validation module 312 validates specification data for a tube rack or other format against the specification rules to determine whether the specification data is valid or not. The specification validation module 312 either generates data or a message indicating the specification data is valid or generates data for an error message.

A calculation module 314 calculates cost associated with preparing a desired plate design in response to the cost detail request 142A based on the designated format data, sequence data, specification data, and packaging options included in the cost detail request 142A. The GUI module 306 then transmits the exemplary cost detail form 492 with the calculated cost to the remote device 110A for display. In an aspect, the calculation module 314 calculates the cost of preparing other format designs, such as tubes.

According to another aspect, a storage module 316 stores plate design data 127A and packaging data 129A in the database 106A in response to the cost detail request 142A. In particular, the storage module 316 stores the designated format data, sequence data, specification data, and packaging options included in the cost detail request 142A in the database 106A. In an additional aspect, the storage module 316 may be modified to store design data 127A and packaging data 129A in the database 106A that is associated with other format designs such as tubes.

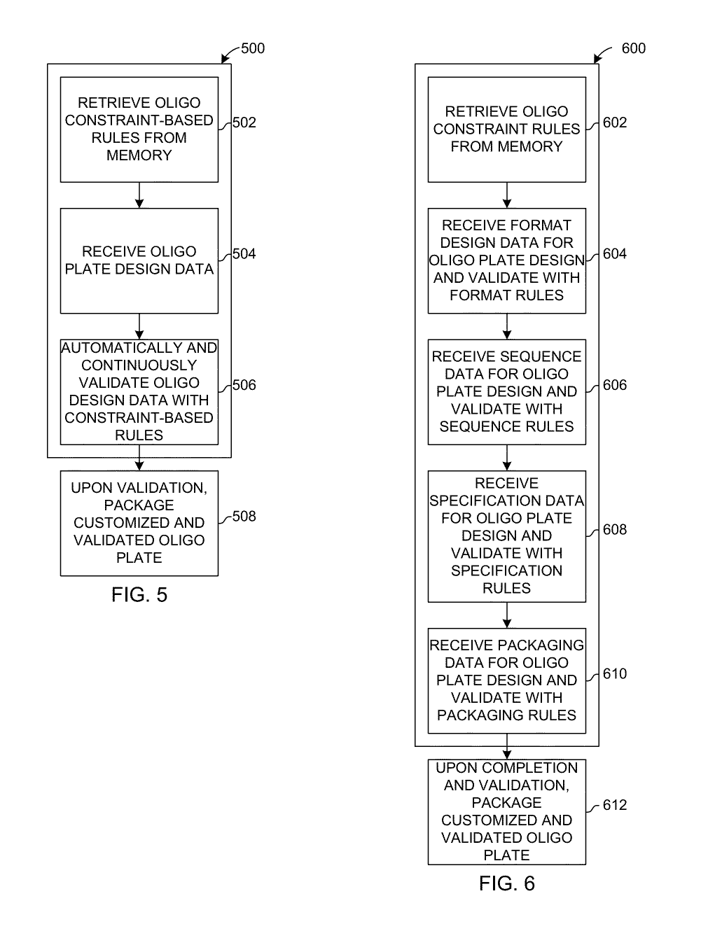

FIG. 5 depicts an exemplary embodiment of a constraint-based rules validation process 500 executed by at least one processor of a computing device, such as with the OCA 104A, 104B, and/or 104C. One or more oligonucleotide constraint-based rules are retrieved from memory by the processor at 502. One or more inputs identifying oligonucleotide plate design data is received at the processor at 504. The oligonucleotide plate design data is automatically and continuously validated at the processor with the one or more oligonucleotide constraint-based rules at 506. Optionally upon validation, the customized and validated oligonucleotide plate design is packaged as a customized plate at 508. The packaged plate then may be shipped to the customer.

FIG. 6 depicts an exemplary embodiment of a constraint-based rules validation process 600 executed by at least one processor of a computing device, such as with the OCA 104A, 104B, and/or 104C. One or more oligonucleotide constraint-based rules are retrieved from memory by the processor at 602. One or more inputs identifying format data for an oligonucleotide plate design is received and validated with format rules at the processor at 604. One or more inputs identifying sequence data for the oligonucleotide plate design is received and validated with sequence rules at the processor at 606. One or more inputs identifying specification data for the oligonucleotide plate design is received and validated with specification rules at the processor at 608. Optionally, one or more inputs identifying packaging data for the oligonucleotide plate design is received at the processor and optionally validated with optional packaging rules at 610. Optionally, upon completion and validation, the customized and validated oligonucleotide plate design is packaged as a customized plate at 612. The packaged plate then may be shipped to the customer.

In one embodiment, inputs for an oligonucleotide plate design are initially received in steps by the OCA and validated in the following order: oligo format data, then oligo sequence data, then oligo specification data, and then optionally packaging data. In another embodiment, a user may edit or re-enter previously validated data for an oligonucleotide plate design, and the OCA then may require entry of following oligonucleotide plate design data (i.e. data to be entered in a next step in the order) in order to complete the constraint-based rules validation process. For example, if format data for an oligonucleotide plate design is edited or re-entered, the user must re-enter or confirm sequence data, then specification data, and then optionally packaging data.

Combinations and/or sub-combinations of the above and systems, modules, components, and methods described herein may be made.

Those skilled in the art will appreciate that variations from the specific embodiments disclosed above are contemplated by the invention. The invention should not be restricted to the above embodiments, but should be measured by the following claims.

The attached appendix, which is incorporated herein, includes examples of the rules discussed above.

We claim the following:

1. A method for generating and validating an oligonucleotide container design comprising oligonucleotide container design data, the method comprising:
retrieving at least one oligonucleotide constraint from a memory at at least one processor;
receiving at least one input identifying at least one portion of the oligonucleotide container design data at the at least one processor; and
automatically and continuously validating the oligonucleotide container design data with the at least one oligonucleotide constraint at the at least one processor.

2. The method of claim 1, further comprising:
identifying an error with the oligonucleotide container design data;
enabling at least one other input to correct the oligonucleotide container design data; and
automatically and continuously validating the corrected oligonucleotide container design data with the at least one oligonucleotide constraint.

3. The method of claim 1, wherein the oligonucleotide container design comprises at least one oligonucleotide, each of the at least one oligonucleotides situated within a single container of at least one container, wherein the single container is a tube or a well in a plate.

4. The method of claim 3, wherein the oligonucleotide container design data comprises format data, sequence data, specification data, packaging options and any combination thereof.

5. The method of claim 4, further comprising:
generating a display with the oligonucleotide container design data;
identifying an error with the oligonucleotide container design data in the display at a container detail level;
enabling selection of an invalid container associated with the error at the container detail level to correct the oligonucleotide container design data;
displaying a container summary level with the oligonucleotide container design data for the selected invalid container;
enabling at least one other input at the container summary level to correct the oligonucleotide container design data;
automatically and continuously validating the corrected oligonucleotide container design data with the at least one oligonucleotide constraints; and
displaying the corrected oligonucleotide container design data at the container detail level upon validation.

6. The method of claim 5, further comprising calculating a cost associated with preparing the oligonucleotide container design and displaying the cost via a graphical user interface.

7. A system for generating and validating an oligonucleotide container design comprising oligonucleotide container design data, the system comprising:
at least one processor;
at least one database comprising at least one rule; and
an application executed by the at least one processor to:
receive at least one input identifying at least one portion of the oligonucleotide container design data at the at least one processor and generate a validation request;
retrieve the at least one rule from the at least one database in response to the validation request received at the at least one processor; and
compare the at least one rule to the oligonucleotide container design data to determine if the oligonucleotide container design data is valid.

8. The system of claim 7, wherein the oligonucleotide container design comprises at least one oligonucleotide, each of the at least one oligonucleotides situated within a single container of at least one container, wherein the single container is a tube or a well in a plate.

9. The system of claim 8, wherein the oligonucleotide container design data comprises format data, sequence data, specification data, at least one packaging option, and any combination thereof.

10. The system of claim 9, wherein the at least one rule comprises at least one format rule, at least one sequence rule, at least one specification rule, and any combination thereof.

11. The system of claim 10, wherein the application is further executed by the processor to:
determine at least one attribute for each single container in the oligonucleotide container design, wherein a first attribute indicates that at least a portion of the oligonucleotide container design data is valid and a second attribute indicates that at least a portion of the oligonucleotide container design data is invalid; and
generate a container design layout for display at a graphical user interface, the container design layout comprising a plurality of display elements, wherein each of the plurality of display elements corresponds to each single container in the oligonucleotide container design, and wherein each of the plurality of display elements is displayed according to a corresponding one of the at least one attributes.

12. The system of claim 11, wherein the application is further executed by the processor to:
receive a selection of a particular display element at the graphical user interface;
display the oligonucleotide container design data that corresponds to the particular display element selected at the graphical user interface;
receive an input modifying the oligonucleotide container design data via the graphical user interface;
generate a modified oligonucleotide container design validation request that includes the modified oligonucleotide container design data;
retrieve the at least one rule from the at least one database in response to the modified oligonucleotide container design validation request received at the at least one processor; and
compare the at least one rule to the oligonucleotide container design data to determine if the oligonucleotide container design data is valid.

13. The system of claim 12, wherein the application is further executed by the processor to:
generate a packaging option menu for display at a graphical user interface comprising a second plurality of display elements, wherein each of the second plurality of display elements corresponds to one of a plurality of packaging options;
receive a selection of a particular display element corresponding to a selected packaging option at the graphical user interface and generate a cost detail request;
calculate a cost associated with preparing the oligonucleotide container design comprising the selected packaging option in response to the cost detail request received at the at the at least one processor; and
display the cost via the graphical user interface.

14. A system for generating and validating an oligonucleotide container design comprising oligonucleotide container design data, wherein the oligonucleotide container design data comprises format data, sequence data, specification data, at least one packaging option, and any combination thereof, the system comprising:
a computing device comprising at least one processor;
at least one database comprising at least one rule, wherein the at least one rule comprises at least one format rule, at least one sequence rule, at least one specification rule, and any combination thereof; and
a CRM configured with an application comprising a plurality of modules executable by the at least one processor, the plurality of modules comprising:
a GUI module to display at least one input form and to receive at least one input identifying at least one portion of the oligonucleotide container design data;
a format validation module to:
retrieve at least one format rule from the at least one database;
compare the at least one format rule to the format data to determine if the format data is valid;
generate a format input form for display by the GUI module comprising at least one display element corresponding to an invalid portion of the format data; and
receive a corrected portion of the format data via the GUI module;
a sequence validation module to:
retrieve at least one sequence rule from the at least one database;
compare the at least one sequence rule to the sequence data to determine if the sequence data is valid;
generate a sequence input form for display by the GUI module comprising at least one second display element corresponding to an invalid portion of the sequence data; and
receive a corrected portion of the sequence data via the GUI module;
a specification validation module to:
retrieve at least one specification rule from the at least one database;
compare the at least one specification rule to the specification data to determine if the specification data is valid;
generate a specification input form for display by the GUI module comprising at least one third display element corresponding to an invalid portion of the specification data; and
receive a corrected portion of the specification data via the GUI module.

15. The system of claim 14, wherein the plurality of modules further comprises a cost calculation module to:
calculate the cost associated with preparing the oligonucleotide container design; and
generate a cost input form for display by the GUI module comprising at least one fourth display element corresponding to the calculated cost.

16. The system of claim 15, wherein the plurality of modules further comprises a storage module to store the oligonucleotide container design and associated design in the database.

17. The system of claim 14, wherein the oligonucleotide container design comprises at least one oligonucleotide, each of the at least one oligonucleotides situated within a single container of at least one container, wherein the single container is a tube or a well in a plate.

18. The system of claim 14, wherein the at least one input form:
displays an identified error with the oligonucleotide container design data in the display at a container detail level; and
enables selection of an invalid container associated with the error at the container detail level to correct the oligonucleotide container design data.


SEQUENCE LISTING (1 sequence)

SEQ ID NO: 1 - DNA, 16 bp, Artificial Sequence
  SYNTHESIZED
agagccctttagagag